(19) United States
(12) Patent Application Publication
(10) Pub. No.: US 2016/0046756 A1
(43) Pub. Date: Feb. 18, 2016

(54) PROCESS FOR PREPARING POLYISOCYANATES AND CATALYST KIT THEREFOR

(71) Applicant: COVESTRO DEUTSCHLAND AG, Leverkusen (DE)

(72) Inventors: Frank RICHTER, Leverkusen (DE); Martin BRAHM, Odenthal (DE)

(21) Appl. No.: 14/778,870

(22) PCT Filed: Mar. 21, 2014
(86) PCT No.: PCT/EP2014/055724

§ 371 Date: Sep. 21, 2015

(30) Foreign Application Priority Data
Mar. 22, 2013 (EP) 13160534.7

(51) Int. Cl. C08G 18/02; B01J 31/02

(52) U.S. Cl. CPC C08G 18/022; B01J 31/0288; B01J 2231/20; B01J 2531/002

(57) ABSTRACT

The application relates to a catalyst kit comprising a trimerisation catalyst for the asymmetric trimerisation of polyisocyanates and a catalyst poison for the trimerisation catalyst, which is characterised in that the trimerisation catalyst and the catalyst poison each have a water content of at most 0.5 wt %. The application furthermore relates to the use of the catalyst kit for the preparation of polyisocyanates containing iminooxadiazinedione groups by oligomerisation of monomeric di- and/or triisocyanates and a process for the preparation of polyisocyanates containing iminooxadiazinedione groups.

The present invention relates to a catalyst kit comprising a trimerisation catalyst for asymmetric trimerisation of polyisocyanates and a catalyst poison for the trimerisation catalyst. The invention furthermore relates to the use of such a catalyst kit for the preparation of polyisocyanates containing iminooxadiazinedione groups by oligomerisation of monomeric di- and/or triisocyanates and a process for the preparation of polyisocyanates containing iminooxadiazinedione groups.

The oligo or polymerisation of isocyanates, summarised here as modification, has been known for a long time. If the modified polyisocyanates contain free NCO groups, which can optionally also have been temporarily deactivated with blocking agents, they are exceptionally high quality starting substances for the preparation of a large number of polyurethane plastics and coating compositions.

A number of industrial processes have become established for isocyanate modification, as a rule the isocyanate to be modified, usually a diisocyanate, being reacted by addition of catalysts, which are then rendered inactive (deactivated) by suitable measures when the desired degree of conversion of the isocyanate to be modified is reached, and the polyisocyanate obtained is as a rule separated off from unreacted monomer. For deactivation of the catalysts, in addition to their thermal decomposition, chemical “neutralisation” (poisoning) in particular has proved suitable for “stopping” the catalysed reaction.

A compilation of these processes of the prior art is to be found in H. J. Laas et al., J. Prakt. Chem. 1994, 336, 185 et. seq.

A specific form of isocyanate modification which leads to products having a high content of iminooxadiazinedione groups (asymmetric isocyanate trimers) in addition to the long-known isocyanurate structures (hitherto often merely called “trimers” for simplification) in the process products is described, inter alia, in EP-A 962455, 962454, 896009, 798299, 447074, 379914, 339396, 315692, 295926 and 235388. (Hydrogen poly)fluorides, preferably with quaternary phosphonium cations as the counter-ion, have proved to be suitable catalysts for this.

A disadvantage of this process of the prior art is that the species used as the catalyst partially decompose to form troublesome by-products, which manifests itself, inter alia, in a successively increasing phosphorus content of the monomer (recyclate) recovered—as a rule by distillation.

Recyclates contaminated in this way can indeed be purified, cf. EP-A 1939171, but such a procedure is associated with additional outlay, which it is expedient to avoid.

The invention was therefore based on the object of providing a process for the preparation of polyisocyanates containing high contents of iminooxadiazinedione groups which does not have the abovementioned disadvantages. The catalysts should have in particular a better stability in the isocyanate medium and should not tend, or should tend less compared with systems of the prior art, to decompose to form troublesome by-products which may become concentrated in the process products, in particular the recyclate.

This object is achieved by a catalyst kit comprising a trimerisation catalyst for the asymmetric trirnerisation of monomeric di- and/or triisocyanates and a catalyst poison for the trimerisation catalyst, wherein the catalyst kit is characterised in that the trimerisation catalyst and the catalyst poison in each case have a water content of at most 0.5 wt. %.

The present invention further provides the use of the catalyst kit according to the invention for the preparation of polyisocyanates containing iminooxadiazinedione groups by oligomerisation of monomeric di- and/or triisocyanates.

The present invention furthermore relates to a process for the preparation of polyisocyanates containing iminooxadiazinedione groups, in which at least one organic di- and/or triisocyanate is reacted in the presence of at least one trimerisation catalyst for the asymmetric trirnerisation of polyisocyanates, and when the reaction has reached a predeterminable degree of conversion, based on the organic di- and/or triisocyanate, it is stopped by addition of at least one catalyst poison for the trimerisation catalyst, wherein the process is characterised in that the trimerisation catalyst and the catalyst poison each have a water content of at most 0.5 wt. % and the total content of water of all the starting substances is in total at most 1 wt. %.

The invention is based on the knowledge that when catalysts and corresponding catalyst poisons, which can also be called “stoppers”, are used the abovementioned requirements can be met if the stated maximum values for the water content are not exceeded.

Compared with catalysis e.g. by quaternary phosphonium salts without using additives which withdraw the water from the catalyst and commercially available toluenesulfonic acid (hydrate) as a stopper (bulk modification), in the process according to the invention under otherwise identical reaction conditions a significantly improved catalyst stability is observed, which manifests itself in significantly lower phosphorus contents of the recyclate.

The low-monomer polyisocyanates containing iminooxadiazinedione groups resulting in the process according to the invention have the same high level of quality as the products which are obtained by previously described processes of the prior art and as a rule cannot be distinguished from these analytically.

When using the catalyst kit, furthermore, the total water content of all the starting substance, that is to say, for example, including the reactants, should not exceed 1 wt. %.

It can be deduced from none of the abovementioned publications of the prior art that a lowering of the water content in the catalysts and catalyst poisons of the prior art preferred for iminooxadiazinedione formation leads to a significant stabilisation of this species in the isocyanate medium. In EP 962 454 water is even explicitly mentioned as a possible additive for the preparation of catalysts containing fluoride ions which can be employed for the preparation of polyisocyanates containing iminooxadiazinedione groups. Since furthermore diisocyanates themselves are extremely reactive towards water, it was rather to be expected that the “dewatering” of the catalyst and the catalyst poison would start rapidly after contact with the isocyanate to be modified and therefore a prior dewatering of the catalyst or catalyst poison should have no influence on the stability of the P-containing species.

The method and manner in which the residual water contained in the catalyst or the catalyst poison as a result of the preparation or absorbed again later—e.g. due to the hygroscopic nature thereof—is withdrawn (distillation, extraction, by chemical reaction with an additive which is harmless in the process, adsorption etc.) is unimportant in the process according to the invention.

With the modification process according to the invention an improved method for the preparation of polyisocyanates containing iminooxadiazinedione groups has therefore become accessible in a simple manner.

In the context of the present invention, further catalysts can also be employed in addition to the trimerisation catalyst. In addition, mixture of various trimerisation catalysts can also be employed, if desired together with further catalysts. These constellations are to be understood, for example, as embodiments of the catalyst kit, of the use thereof or of the process according to the invention.

In an embodiment of the catalyst according to the invention, the trimerisation catalyst and the catalyst poison each independently of each other have a water content of at most 0.4 wt. %, preferably of at most 0.3 wt. % and particularly preferably of at most 0.2 wt. %. The formation rate of undesirable by-products can be reduced further by this means.

The trimerisation catalyst can comprise at least one quaternary phosphonium salt or consist of this. Preferred trimerisation catalysts are those based on quaternary phosphonium salts of which the cations correspond to the general formula R₄⁺, wherein R represents identical or different, optionally branched, aliphatic, aromatic and/or araliphatic C₁-C₂₀ radicals and optionally two or more substituents R can also form with one another and with the phosphorus atom saturated or unsaturated rings. Individual phosphonium salts as well as mixtures of various phosphonium salts or mixtures of phosphonium salts with other catalysts which accelerate the iminooxadiazinedione formation can be employed.

Particularly preferred trimerisation catalysts are quaternary phosphonium polyfluorides of the formula R₄P⁺F⁻·n(HF), wherein R represents identical or different, optionally branched, aliphatic, aromatic and/or araliphatic C₁-C₂₀ radicals and optionally two or more substituents R can also form with one another and with the phosphorus atom saturated or unsaturated rings and n can assume any desired values between 0.1 and 20.

Individual phosphonium polyfluorides of the formula R₄P⁺F⁻·n(HF) as well as mixtures of these salts or mixtures of phosphonium polyfluorides of the formula R₄P⁺F⁻·n(HF) with other catalysts which accelerate the iminooxadiazinedione formation can be employed.

Possible catalyst poisons, i.e. stoppers, are quite generally anhydrous acids having a pKa value below 3.2 (pKa value of HF), preferably below 1. The catalyst poison can he employed as an individual compound, as well as a mixture of various catalyst poisons. Preferred stoppers are inorganic or organic acids having a good solubility in organic media and which lead to no undesirable reactions with the isocyanates to be reacted and/or the process products. For example, anhydrous HCl, preferably as a solution of the adduct on the isocyanate to be reacted (carbamic acid chloride) in excess isocyanate, or in another anhydrous solution, e.g. in polar organic solvents, are suitable. Acid esters of P- and S-containing acids and these acids themselves are furthermore suitable. Examples which may be mentioned are: phosphoric acid, phosphoric acid mono- and diesters with identical or different, optionally branched, aliphatic, aromatic and/or araliphatic C₁-C₂₀ radicals in the ester function, such as e.g.: mono- and dialkyl phosphates, optionally also as mixtures of the 3 abovementioned compound classes, which can optionally also contain small amounts of the particular triesters, such as result e.g. in the reaction of H₃PO₄ or POCl₃ with alcohols or phenols and are marketed e.g. under the trade name Hordaphos, sulfuric acid, sulfonic and sulfinic acids and the at least monobasic esters derived from them having identical or different, optionally branched, aliphatic, aromatic and/or araliphatic C₁-C₂₀ substituents on the sulfur atom or in the ester radical, such as e.g. methanesulfonic acid, toluenesulfonic acid, alkylbenzene- or alkylnaphthalenesulfonic acids with one or more identical or different, optionally branched C₁-C₂₀ substituents on the benzene or naphthalene ring and derivatives of the abovementioned compounds containing more than one acid function per molecule, such as are marketed e.g. under the trade name Nacure and K-Cure.

The catalyst kit can comprise additives and/or solvents. These can also be employed in the context of the process according to the invention independently of the catalyst kit. These are to be understood as meaning, for example, substances which do not influence the water content of the catalyst, such as alcohols, stabilisers (e.g. sterically hindered phenols or amines), antioxidants etc., which are conventionally used in polyurethane chemistry. According to the invention, the water content thereof in particular is likewise below 0.5 wt. %, based on these components.

With respect to the process according to the invention, it is provided for the reaction to be stopped when a predeterminable degree of conversion, based on the organic di- and/or triisocyanate, is reached by addition of at least one catalyst poison for the trimerisation catalyst. The degree of conversion can be, for example, 5 to 80 wt. % of the organic di- and/or triisocyanate, in particular 10 to 60 wt. % of the organic di- and/or triisocyanate.

The process according to the invention can be carried out in the temperature range of from 0° C. to +250° C., preferably at 20 to 180° C., particularly preferably at 40 to 150° C., and interrupted at any desired degrees of conversion, preferably after that mentioned above.

The requirement of trimerisation catalyst in the process according to the invention as a rule does not differ from that observed in the bulk modification of the prior art. The trimerisation catalyst can be employed, for example, in an amount of from 1 mol-ppm to 1 mol %, preferably from 5 mol-ppm to 0.1 mol %, based on the organic di- and/or triisocyanate.

The catalyst can be employed in the process according to the invention in undiluted form or as a solution in solvents. Possible solvents in this context are all compounds which do not react with the catalyst and are capable of dissolving it to a sufficient extent, e.g. aliphatic or aromatic hydrocarbons, alcohols, ketones, esters and ethers. Alcohols are preferably used.

After the catalysed reaction, in the process according to the invention when the desired degree of conversion is reached the deactivation of the trimerisation catalyst is carried out. According to the invention it is brought about by addition of a catalyst poison, for example as described above.

The unreacted monomer and solvents optionally co-used can then be separated off with the aid of all known separation techniques, such as e.g. distillation, optionally in the specific embodiment of thin film distillation, extraction or crystallisation/filtration. Combinations of two or more of these techniques can of course also be used. Preferably, the unreacted monomer is separated off by distillation.

Where a separating off is carried out, the products according to the invention have a residual monomer content of <0.5%, preferably <0.3 wt. %, particularly preferably <0.25%, after the separating off.

Preferably, however, the unreacted monomer is separated off. If, for example, the polyisocyanate prepared according to the invention is still to contain free, unreacted monomer, such as is of interest e.g. for further processing to NCO-blocked products, after deactivation of the catalyst in particular separating off of the monomer can he omitted in such cases.

According to a particular embodiment of the process according to the invention, the oligomerisation can he carried out in a tube reactor. The lower tendency of the catalysts according to the invention to decompose is likewise benefited from here. This procedure furthermore is advantageous because this allows continuous operation.

All known (di)isocyanates of the prior art can in principle be employed, individually or in any desired mixtures with one another, for carrying out the process according to the invention.

There may be mentioned in particular: hexamethylene-diisocyanate (HDI), 2-methylpentane-1,5-diisocyanate, 2,4,4-trimethyl-1,6-hexane-diisocyanate, 2,2,4-trimethyl-1,6-hexane-diisocyanate, 4-isocyanatomethyl-1,8-octane-diisocyanate, 3(4)-isocyanatomethyl-1-methylcyclohexyl-isocyanate (IMCI), isophorone-diisocyanate (IPDI), 1,3- and 1,4-bis(isocyanatomethyl)benzene (XDI), 1,3- and 1,4-bis(isocyanatomethyl)cyclohexane (H6XDI), 2,4- and 2,6-toluylene-diisocyanate (TDI), bis(4-isocyanatophenyl)methane (4,4′MDI), 4-isocyanatophenyl-2-isocyanatophenylmethane (2,4′MDI) and polynuclear products which are accessible by formaldehyde-aniline polycondensation and subsequent conversion of the resulting (poly)amines into the corresponding (poly)isocyanates (polymeric MDI).

The following are preferably employed. hexamethylene-diisocyanate (HDI), 2-methylpentane-1,5-diisocyanate, 2,4,4-trimethyl-1,6-hexane-diisocyanate, 2,2,4-trimethyl-1,6-hexane-diisocyanate, 4-isocyanatomethyl-1,8-octane-diisocyanate, 3(4)-isocyanatomethyl-1-methylcyclohexyl-isocyanate (IMCI), isophorone-diisocyanate (IPDI), 1,3- and 1,4-bis(isocyanatomethyl)benzene (XDI) and 1,3- and 1,4-bis(isocyanatomethyl)cyclohexane (H6XDI).

The process by which the abovementioned (poly)isocyanates are generated, i.e. with or without use of phosgene, is unimportant here.

The products and product mixtures obtainable by the process according to the invention are consequently starting materials which can be used in diverse ways for the preparation of optionally foamed plastic(s) as well as lacquers, coating compositions, adhesives and additives. They are suitable in particular for the preparation of optionally water-dispersible one- and two-component polyurethane lacquers, optionally in NCO-blocked form, because of their reduced solution and melt viscosity compared with products (predominantly) based on isocyanurate polyisocyanate, with an otherwise equally high or improved profile of properties. The HDI-based process products according to the invention are thus more stable towards the occurrence of flocculation or clouding than corresponding isocyanurate-based products, even in a high dilution in lacquer solvents.

They can be employed in the pure form or in combination with other isocyanate derivatives of the prior art, such as e.g. polyisocyanates containing uretdione, biuret, allophanate, isocyanurate and/or urethane groups, the free NCO groups of which have optionally been deactivated with blocking agents.

The following comparative examples and examples are intended to illustrate the invention in more detail, but without limiting it.

### EXAMPLES

Unless noted otherwise, all the amounts stated relate to the weight.

The NCO content of the resins described in the examples and comparative examples was determined by titration in accordance with DIN 53 185.

The phosphorus content of all the samples was determined by x-ray fluorescence (XRF) analysis.

The water content of the catalyst solutions was determined by means of Karl-Fischer titration in accordance with DIN 51777-2

Mol % data were determined by NMR spectroscopy and unless indicated otherwise always relate to the sum of the NCO secondary products. The measurements were performed on the DPX 400 and DRX 700 apparatuses of Brucker on approx. 5% strength (¹H-NMR) or 50% strength (¹³C-NMR) samples in dry C₆D₆ at a frequency of 400 or 700 MHz (¹H-NMR) or 100 or 176 MHz (¹³C-NMR). Small amounts of tetramethylsilane in the solvent with 0 ppm ¹H-NMR chem. shift were used as the reference for the ppm scale. Alternatively the signal of the C₆D₅H contained in the solvent was used as the reference: 7.15 ppm ¹H-NMR chem. shift, 128.02 ppm ¹³C-NMR chem. shift. Data for the chemical shift of the compounds in question were taken from the literature (cf. D. Wendisch, H. Reiff and D. Dieterich, Die Angewandte Makromolekulare Chemie 141, 1986, 173-183 and literature cited therein as well as EP-A 896 009.

The dynamic viscosities were determined at 23° C. with a VT 550 viscometer from Haake. By measurements at different shear rates it was ensured that the flow properties of the polyisocyanate mixtures according to the invention which are described, like also those of the comparison products, correspond to those of ideal Newtonian fluids. It is therefore not necessary to state the shear rate.

The residual monomer contents were determined by gas chromatography.

Unless stated otherwise, all the reactions were carried out under a nitrogen atmosphere.

The diisocyanates used are products of Bayer MaterialScience AG, D-51368 Leverkusen, all the other commercially available chemicals were obtained from Aldrich, D-82018 Taufkirchen. The preparation of the hydrogen polyfluoride catalysts is described inter alia in EP-A 962454 and literature cited therein.

### Example 1 (Comparative Example)

1,000 g of HDI were initially introduced into a double-walled around glass vessel which was temperature-controlled at 60° C.; by an external circulation and had a stirrer, a reflux condenser connected to an inert gas unit (nitrogen/vacuum) and a thermometer, and were freed from dissolved gases by stirring in vacuo (0.1 mbar) for one hour. After ventilating with nitrogen, 603 mg of an approx. 70% strength isopropanolic tetrabutylphosphonium hydrogen difluoride solution (water content: 0.8%, phosphorus content: 7.6%) were metered into the vessel in portions such that the temperature of the reaction mixture did not exceed 62° C. After approx. 1 mol of NCO groups had reacted, the catalyst was deactivated by addition of an amount of p-toluenesulfonic acid monohydrate (as an approx. 40% strength solution in isopropanol, water content 5.2%) equivalent to the catalyst and the mixture was subsequently stirred at the reaction temperature for a further 30 min and then worked up. The working up was carried out by vacuum distillation in a thin film evaporator, molecular evaporator (ME) type, with an upstream pre-evaporator (PE) (distillation data: pressure: 0.08+/−0.04 mbar, PE temperature: 140° C., ME temperature: 120° C.), unreacted monomer being separated as the distillate and the low-monomer polyisocyanate resin as the bottom product (starting run, Example 1-A). The polyisocyanate resin was separated and the distillate was collected in a second ground glass stirred apparatus of identical construction to the first, and was topped up to the starting amount (1,000 g) with freshly degassed HDI. Catalyst was then added again and the procedure was as described above. This procedure was repeated five times in total (catalyst doses: 530 mg; 498 mg; 492 mg; 486 mg and 466 mg). The phosphorus content of the recyclate monomer remaining at the end of the series of experiments was 78 ppm. The averaged data of the polyisocyanate resins obtained in experiments 1-B to 1-F are as follows:
Resin yield (based on the HIM employed): 18.2%
NCO content: 23.3%
Viscosity: 720 mPas/23° C.
Iminooxadiazinediones: 49 mol %*
Isocyanurates: 46 mol %*
Uretdiones: 5 mol %*
*=based on the sum of the NCO secondary products formed in the modification reaction

### Example 2 (according to the invention)

The procedure was as described in Comparative Example 1, with the difference that the water content of the catalyst used had been lowered to 820 ppm beforehand by adding to the catalyst solution an amount of trimethyl orthoacetate equimolar to the water content, and instead of the water-containing toluenesulfonic acid a solution of the sulfonic acid (equimolar to the catalyst) in toluene/remainder isopropanol depleted to a water content of 0.28% by azeotropic distillation with toluene was employed.

The phosphorus content of the recyclate monomer remaining at the end of the series of experiments was 35 ppm. The averaged data of the polyisocyanate resins obtained in experiments 2-B to 2-F are as follows:
Resin yield (based on the HDI employed): 18.5%
NCO content: 23.5%
Viscosity: 685 mPas/23° C.
Iminooxadiazinediones: 52 mol %*
Isocyanurates: 43 mol %*
Uretdiones: 5 mol %*
*=based on the sum of the NCO secondary products formed in the modification reaction

### Example 3 (According to the Invention)

The procedure was as described in Example 2, with the difference that the water content of the catalyst used had been lowered to 1,010 ppm beforehand by adding to the catalyst solution an amount of triethyl orthoacetate equimolar to the water content.

The phosphorus content of the recyclate monomer remaining at the end of the series of experiments was 32 ppm. The averaged data of the polyisocyanate resins obtained in experiments 3-B to 3-F are as follows:
Resin yield (based on the HDI employed): 19.0%
NCO content: 23.4%
Viscosity: 715 mPas/23° C.
Iminooxadiazinediones: 53 mol %*
Isocyanurates: 42 mol %*
Uretdiones: 5 mol %*
*=based on the sum of the NCO secondary products formed in the modification reaction

### Example 4 (According to the Invention)

The procedure was as described in Example 3, with the difference that instead of the (virtually) anhydrous toluenesulfonic acid dodecylbenzenesulfonic acid (water content: 0.25%) was employed.

The phosphorus content of the recyclate monomer remaining at the end of the series of experiments was 32 ppm, The averaged data of the polyisocyanate resins obtained in experiments 3-B to 3-F are as follows:
Resin yield (based on the HDI employed): 18.9%
NCO content: 23.5%
Viscosity: 720 mPas/23° C.
Iminooxadiazinediones: 53 mol %*
Isocyanurates: 42 mol %*
Uretdiones: 5 mol %*
*=based on the sum of the NCO secondary products formed in the modification reaction

1-15. (canceled)

16. A catalyst kit comprising a trimerisation catalyst for asymmetric trimerisation of polyisocyanates and a catalyst poison for the trimerisation catalyst, wherein the trimerisation catalyst and the catalyst poison each have a water content of at most 0.5 wt. %.

17. The catalyst kit according to claim 16, wherein the trimerisation catalyst and the catalyst poison each independently of each other have a water content of at most 0.4 wt. %.

18. The catalyst kit according to claim 16, wherein the trimerisation catalyst comprises at least one quaternary phosphonium salt.

19. The catalyst kit according to claim 18, wherein the quaternary phosphonium salt has the general formula R₄P⁺X⁻, wherein the radicals R each independently of each other are identical or different, optionally branched, aliphatic, aromatic and/or araliphatic C1-C20 radicals and/or at least in each case two of the radicals R together with the phosphorus atom form saturated or unsaturated rings and X is a halogen.

20. The catalyst kit according to claim 18, wherein the quaternary phosphonium salt has the general formula R₄P⁺F⁻·n(HF), wherein n has a value between 0.1 and 20 and wherein the radicals R each independently of each other are identical or different, optionally branched, aliphatic, aromatic and/or araliphatic C1-C20 radicals and/or at least in each case two of the radicals R together with the phosphorus atom form saturated or unsaturated rings.

21. The catalyst kit according to claim 16, wherein the catalyst poison is selected from anhydrous acids having a pKa value of 3.2 or less, in particular from anhydrous HCl, anhydrous phosphorus- and sulfur-containing acids, esters thereof, acid halides thereof and combinations of these.

22. A method for the preparation of polyisocyanates containing iminooxadiazinedione groups by oligomerisation of monomeric di- and/or triisocyanates comprising utilising the catalyst kit according to claim 16.

23. A process for the preparation of polyisocyanates containing iminooxadiazinedione groups, comprising reacting at least one organic di- and/or triisocyanate in the presence of at least one trimerisation catalyst for the asymmetric trimerisation of polyisocyanates, and when the reaction has reached a predeterminable degree of conversion, based on the organic di- and/or triisocyanate, and stopping the reaction by addition of at least one catalyst poison for the trimerisation catalyst, wherein the trimerisation catalyst and the catalyst poison each have a water content of at most 0.5 wt. % and the total content of water of all the starting substances is in total at most 1 wt. %.

24. The process according to claim 23, wherein the degree of conversion is 5 to 80 wt. % of the organic di- and/or triisocyanate.

25. The process according to claim 23, wherein the reaction is carried out at a temperature of from 0° C. to +250° C.

26. The Process according to claim 23, wherein the amount of the trimerisation catalyst is from 1 mol-ppm to 1 mol %, based on the organic di- and/or triisocyanate.

27. The process according to claim 23, wherein the reaction is carried out in the presence of at least one solvent and/or one additive.

28. The process according to claim 23, comprising dissolving the trimerisation catalyst in a solvent before the addition to the organic di- and/or triisocyanate.

29. The process according to claim 23, comprising separating off unreacted organic di- and/or triisocyanate after the degree of conversion has been reached.

30. The process according to claim 23, wherein the reaction is carried out in a tube reactor.
